(19) United States
(12) Patent Application Publication
(10) Pub. No.: US 2019/0238977 A1
(43) Pub. Date: Aug. 1, 2019

(54) MOUNT FOR A MINIATURE MICROPHONE

(71) Applicant: Jan Juhler, Holte (DK)

(72) Inventor: Jan Juhler, Holte (DK)

(21) Appl. No.: 16/315,121

(22) PCT Filed: Jul. 4, 2017
(86) PCT No.: PCT/DK2017/050225

§ 371 Date: Jan. 3, 2019

(30) Foreign Application Priority Data
Jul. 5, 2016 (DK) PA 2016 70497

(51) Int. Cl. H04R 1/28; H04R 1/08

(52) U.S. Cl. CPC H04R 1/2892; H04R 2201/023; H04R 1/08

(57) ABSTRACT

A microphone mount arranged to receive a microphone (MC), the microphone mount comprising an inner tube (T1) forming an inner cavity (CI) with an opening (OP11) arranged to receive a microphone for capturing sound in the inner cavity (CI) of the inner tube (T1), and with one or more openings (OP12) arranged to allow acoustic waves to enter the inner cavity (CI). An outer tube (T2) forming an inner cavity (C2) with first and second ends having an openings (OP21, OP22). The inner tube (T1) is arranged in the inner cavity (C2) of the outer tube (T2). A sound reflecting surface (R) is arranged at a distance from the second end of the outer tube (T2) so as to reflect incoming sound waves into the inner cavity of the outer tube (T2). Such microphone mount can provide a substantial acoustical amplification of sound in the frequency range 4-10 kHz, to allow clear voice recordings even if hidden behind a person's clothes, such as hidden behind a tie. This allows applications such as high quality recording of voice with hidden microphone during film recordings.

### FIELD OF THE INVENTION

The present invention relates to the field of audio, more specifically to the field of high quality audio recordings, especially to mounts for miniature microphones to allow miniature microphones to be hidden behind a person's clothes during recording of the person's voice, e.g. during film recordings.

### BACKGROUND OF THE INVENTION

In many video or film productions, two or more cameras are used to capture images during a scene, one for close-ups and one for capturing the overview of the scene. This means that for recording of sound of person's voice when speaking in the scene, it has become complicated to use clearly visible microphones held by a boom operator, as it is likely that the microphone will be visible in the overview picture.

For this reason, hidden microphones to be hidden behind the clothes worn by the persons to be filmed, e.g. actors. However, often this results in an unclear sound of the recorded voices, resulting in poor speech intelligibility. This is due to the fact that hidden microphones are sometimes placed away from the speaker's mouth, and due to the fact that such microphone capture vibrations of the speaker's body resulting in a murmuring sound, and still further, the voice sound is attenuated by the clothes.

### SUMMARY OF THE INVENTION

Thus, according to the above description, it is an object of the present invention to provide a microphone or a mount for an existing miniature microphone which is capable of being worn by a person, hidden behind clothes, and still provides a clear recording of a person's voice.

In a first aspect, the invention provides a microphone mount arranged to receive a microphone, the microphone mount comprising

an inner chamber, such as an inner tube, forming an inner cavity, wherein a first end of the inner tube has an opening arranged to receive a microphone for capturing sound in the inner cavity of the inner chamber, and with one or more openings arranged to allow acoustic waves to enter the inner cavity from an outer surface of the inner chamber,

an outer chamber, forming an inner cavity having an opening, and wherein the inner cavity of the outer chamber is shaped to accommodate at least a part of the inner chamber, and

a sound reflecting surface arranged so as to reflect sound waves into the inner cavity of the outer chamber.

It is to be understood that the inner chamber and outer chamber may be inner and outer tubes, or the chambers may have other shapes. In the following description, it is to be understood that ‘inner tube’ may be interchanged by ‘inner chamber’, as well as ‘inner tube’ and ‘inner chamber’ may be interchanged. Such microphone mount is advantageous, since it can be used with existing high quality miniature microphone and to result in a clear voice recording, when placed and hidden behind clothes, e.g. a tie, of a person, namely with the first ends of the tubes facing upwards towards the person's mouth. This is possible with the inner/outer tube and sound reflecting surface design which allows a microacoustic labyrinth effect for sound coming from the person's mouth, which enters the outer tube via its first end (facing toward the mouth of the person) and via its second end due to reflection from the sound reflecting surface.

With the inner tube positioned inside the outer tube, sound waves are reflecting at the inner surface of the outer tube and thus enters the inner cavity of the inner tube via the openings therein, and inside the inner cavity of the inner tube, sound is finally captured by a microphone, preferably a pressure gradient type of microphone. With this acoustic micro labyrinth effect, it is possible to acoustically amplify sound in the frequency range 3-10 kHz which serves to provide a more clear sound with enhanced speech intelligibility, thus compensating for the attenuation effect of the clothes, e.g. tie, and the position away from the person's mouth. Further, the microphone mount design introduces a number of short sound reflections, i.e. act like an acoustic delay-line, which introduces reflections within the first 10 ms of the direct sound arriving at the microphone, and this itself also introduces a positive “airy” effect on the perceived sound. It has further been found that the microphone mount is also advantageous for use in recording sound from a musical instrument, e.g. an acoustic guitar or a piano.

Further, the microphone mount design is suited for manufacturing in a soft or flexible material which can help to reduce pick-up of vibrations from the person's body, and helps to reduce noise (such as crackling noise) from friction with the clothes when the person moves.

Thus, altogether the microphone mount is highly suitable for recording of a person's, e.g. an actor's, voice during video and film recordings, where a hidden microphone position is preferred along with a clear intelligibility of the person's voice. However, it is to be understood that it can be used as a visible microphone mount as well.

In the following, preferred features and embodiments of the first aspect will be described.

The inner chamber, the outer chamber, and the sound reflecting surface are preferably dimensioned so as to provide an acoustic labyrinth effect between incoming acoustic waves and a position in the inner cavity of the inner tube where sound can be captured by a microphone, so that sound in the frequency range 4-6 kHz, preferably a wideband 3-10 kHz, e.g. 3.5-8 kHz is amplified, preferably by at least 3 dB, more preferably by at least 6 dB. An acoustic amplification in this frequency range results in a perceived more clear sound recording of a human voice, especially of consonants, and it further provides a better speech intelligibility.

The inner tube, the outer tube, and the sound reflecting surface are preferably designed so as to act as an acoustic delay line.

Said one or more openings of the inner tube preferably comprises one or more apertures or slids arranged to allow acoustic waves reflected from a wall of the inner cavity of the outer tube to enter the inner cavity of the inner tube. Especially, said one or more apertures or slids may be positioned between the first end of the inner tube and a second end of the inner tube opposite the first end. Preferably, the second end of the inner tube is closed. Especially, said one or more openings of the inner tube may be constituted by at least two apertures or slids, such as at least two apertures extending parallel with a longitudinal axis of the inner tube at different angular positions around a circumference of the inner tube. This allows capturing of sound wave reflected at various positions on the inner wall of the inner cavity of the outer tube. Especially, said one or more openings may comprise four apertures extending parallel with a longitudinal axis of the inner tube at different angular positions around a circumference of the inner tube. Such as each of the four apertures having a length of 2-4 mm and a width of 0.5 mm to 2 mm, preferably a length of 3 mm and a width of 1 mm, and positioned near the second end of the inner tube. Preferably, the major part or all of of such apertures or slids are arranged in the inside the inner cavity of the outer tube, so as to receive sound waves which have been reflected on the inner wall of the inner cavity of the outer tube.

A second end of the inner tube (i.e. opposite the first end of the inner tube) is preferably closed. Especially, this second end of the inner tube may have a spherical shape. Such spherical shape facing towards the sound reflecting surface outside the open second end of the outer tube serves to diffract or disperse sound waves reflected by the sound reflecting surface into the inner cavity of the outer tube, so as to provide a more random distribution of sound waves entering the inner cavity of the outer tube.

Preferably, at least a part of, more preferably all of, said one or more limited openings of the inner tube are positioned in the inner cavity of the outer tube. Hereby, no direct sound from the surroundings will enter the inner cavity of the inner tube.

The inner tube may have a circular or substantially circular cross section, such as the inner tube having a slightly decreasing outer diameter towards the first end where a microphone is arranged to be received. Preferably, this opening in the first end of the inner tube is shaped to provide an acoustically tight fit around a specific microphone, preferably a microphone having a circular cross section. E.g. if the inner tube is made of flexible and soft material, such tight fit is possible, and at the same time the opening can serve to fix the position of the microphone.

The outer tube may have an elliptical or substantially elliptical cross section, such as the outer tube forming an inner cavity with as an elliptical or substantially elliptical cross section, such as the outer tube forming an inner cavity with as a constant or substantially elliptical or substantially elliptical cross section from the first end to the second end. Such elliptical inner cavity of the outer tube in combination with a circular inner tube positioned near the center of the elliptical inner cavity has been found to provide an advantageous micro acoustic labyrinth effect. However, the inner and outer tubes may also have other cross sectional shapes which will allow similar effects.

In preferred embodiments, the inner tube and the outer tube are formed as separate elements arranged to be assembled. Especially, this can be obtained if the outer tube has a trace along its inner wall serving to engage with an outer part of the inner tube, so as to allow insertion of the inner tube into the inner cavity of the outer tube along the trace.

The sound reflecting surface, e.g. having a plane portion, is preferably perpendicular to or substantially perpendicular to a longitudinal axis of the outer tube. In this way, the sound reflecting surface will reflect sound waves from the person's mouth and transmit them into the inner cavity of the outer tube. The acoustic reflection from the sound reflecting surface adds a delay compared to the direct sound entering the inner cavity of the outer tube.

In one embodiment, the sound reflecting surface and the outer tube are constituted by one single monolithic element, such as one single monolithic element formed by a silicone or rubber based material. Especially, said one single monolithic element may comprising a protruding part arranged for fixing the microphone mount to a person or a person's clothing, such as the protruding part having one or more through-going holes for receiving a fixing string or wire, such as the protruding part being arranged at the first end of the outer tube. Such combined monolithic element can be manufactured in an easy way in a flexible material in an, e.g. if made in a rubber or the like. E.g. such element may be 3D printed. In a similar way. The inner tube can be manufactured as one monolithic element arranged for being assembled with the outer tube.

The outer tube preferably has a length of 1-4 cm, preferably 2-3 cm, measured from the first end to the second end. The inner tube preferably has a length of 1-4 cm, preferably 2-3 cm, measured from the first end to the second end. Especially, the inner tube may have a length equal to or substantially equal to a length of the outer tube, and wherein the first end of the inner tube, and the first end of the outer tube are longitudinally aligned.

The sound reflecting surface is preferably arranged at a distance of 2-15 mm, such as 3-10 mm, outside the second end of the outer tube. E.g. the sound reflecting surface may constitute the second end of the outer tube, and wherein said second opening in the outer tube is arranged at an outer wall of the outer tube, adjacent to the sound reflecting surface, so as to allow acoustic waves to enter the second opening and to be reflected by the sound reflecting surface.

In preferred embodiments, a cross sectional area of the inner cavity of the outer tube is a factor of 2-4 times an outer cross sectional area of the inner tube. A cross sectional area of the inner cavity of the outer tube is preferably 0.5-2 cm², most preferably 0.7-1.5 cm².

Especially, the opening in the first end of the inner tube may have a diameter of 2-4 mm. This will ensure fitting to relevant existing microphones.

Especially, the inner tube is designed and positioned in relation the outer tube, so that sound waves will primarily enter the inner cavity of the inner tube via said one or more openings.

At least an outer surface of the outer tube may be formed by a material serving to reduce or eliminate acoustic noise caused by friction between clothing and the outer surface of the outer tube, preferably a soft or flexible material. Especially, at least the outer surface of the outer tube may be formed by a material comprising a substantial amount of: silicone and/or rubber, such as formed by silicone or rubber. The microphone mount may be at least partly, or completely, manufactured by a rubber material, e.g. a natural rubber material, as a specific example a natural rubber material such as available from the company Linatex®.

However, it is to be understood that other materials such as polymeric materials or metals may be used for at least part of the microphone mount.

The sound reflecting surface may be flat or slightly curved, and preferably formed by a material serving to at least reflect more than 30%, preferably more than 50%, of sound energy at frequencies in the range 3-10 kHz.

In some embodiments, the outer chamber is a flat structure forming a flat inner cavity arranged for position of at least an end of a tube shaped inner chamber. Especially, the outer chamber may have a generally circular or elliptical outer shape, such as having an outer shape as a flat dome, e.g. a general UFO shaped outer chamber. The outer chamber may have one opening arranged to receive incoming sound and having a reflecting surface arranged to reflect sound into the inner cavity. Especially, said one opening serves in addition as opening for receiving a microphone to enter the inner tube. A magnet or a magnetic material may be attached to the outer chamber T2 so as to allow the magnet or magnetic material to fix the microphone mount onto a part of a person's clothes by means of a matching magnetic material or magnet.

In some embodiments, the inner cavity of the outer chamber is tube shaped with first and second openings at respective ends of the tube shape, serving to reflect incoming sound to guide sound towards the inner cavity of the inner chamber. Especially, an opening inside the tube shaped inner cavity of the outer chamber serves to connect the inner cavity of the outer chamber with the inner cavity of the inner chamber. A cross sectional area of the tube shaped inner cavity C2 may especially decrease from the first opening towards the opening connecting to the inner cavity of the inner chamber. Likewise, a cross sectional area of the tube shaped inner cavity may decrease from the second opening towards the opening connecting to the inner cavity of the inner chamber. A structure forming the outer chamber and the inner chamber is preferably a monolithic structure, such as a monolithic structure formed by a rubber material. The microphone mount may comprise a snap-lock mechanism arranged to attach the microphone mount onto a microphone, e.g. a microphone fixed on a wire of an ear plug device. The snap lock mechanism may be monolithically formed with the structure forming the inner and outer chambers. To further increase high frequency content in the captured sound, the microphone mount may comprise a reflecting element, such as a spherical element, arranged at or near one or both of the openings to the outer chamber, so as to reflect sound into the inner cavity of the outer chamber. This microphone mount embodiment may form part of an ear plug device, especially the microphone mount is arranged to be attached to an electrical wire of the ear plug device or to be attached to a microphone arranged on an electrical wire of the ear plug device.

In a second aspect, the invention provides a microphone assembly comprising a microphone mount according to the first aspect, and a microphone, preferably a pressure gradient microphone, mounted in an opening of the inner chamber, such as an inner tube, of the microphone mount.

In a third aspect, the invention provides use of a microphone mount according to the first aspect. Especially, the use of the microphone mount according to the first aspect may be for recording of a person's voice, or for recording sound from a musical instrument, such as a guitar or a piano.

In a fourth aspect, the invention provides a method of hiding a miniature microphone behind a piece of clothes, such as a tie, being worn by person, the method comprising

providing a microphone mount according to the first aspect,

mounting a microphone in an opening in the inner chamber, such as an inner tube, of the microphone mount, and

fixing the microphone mount behind the piece of clothes.

In a fifth aspect, the invention provides a method of recording a person's voice during recording of motion pictures of the person, the method comprising hiding a microphone behind a piece of clothes worn the person according to the fourth aspect.

In a sixth aspect, the invention provides data representing the microphone mount according to the first aspect, wherein said data allows a manufacturing device, e.g. a 3D printer, to manufacture the microphone mount, or at least parts thereof, accordingly.

It is to be understood that the microphone mount may be manufactured in various ways, e.g. CNC milling process or in a casting process. Especially, milling process of a casting process are preferred in combination with monolithic elements of silicone or rubber based materials.

It is appreciated that the same advantages and embodiments described for the first aspect apply as well for the second, third, fourth, fifth, and sixth aspects. Further, it is appreciated that the described embodiments can be intermixed in any way between all the mentioned aspects.

### BRIEF DESCRIPTION OF THE FIGURES

The invention will now be described in more detail with regard to the accompanying figures of which

FIG. 1a illustrates a sketch of a preferred microphone mount embodiment in a top view and in a section view,

FIG. 1b illustrates a section view with a miniature microphone mounted in the inner tube,

FIG. 2 illustrates a 3D drawing in a transparent view to make the inner tube visible through the outer tube,

FIG. 3 illustrates a 3D cut-away drawing,

FIG. 4 illustrates a 3D view drawing,

FIGS. 5a and 5b illustrates sketches of an embodiment in different views,

FIGS. 6a-6c show different views of an alternative embodiment of the microphone mount of FIGS. 1-5,

FIG. 7 shows an exploded view of a microphone mount embodiment to be worn hidden behind clothes of a person,

FIGS. 8a-8e show different views of an embodiment to be mounted on a microphone on a wire of an ear plug device, and

FIGS. 9a-9e show different views of an alternative to the embodiment of FIGS. 8a-8e with spherical elements at the openings.

The figures illustrate specific ways of implementing the present invention and are not to be construed as being limiting to other possible embodiments falling within the scope of the attached claim set.

### DETAILED DESCRIPTION OF THE INVENTION

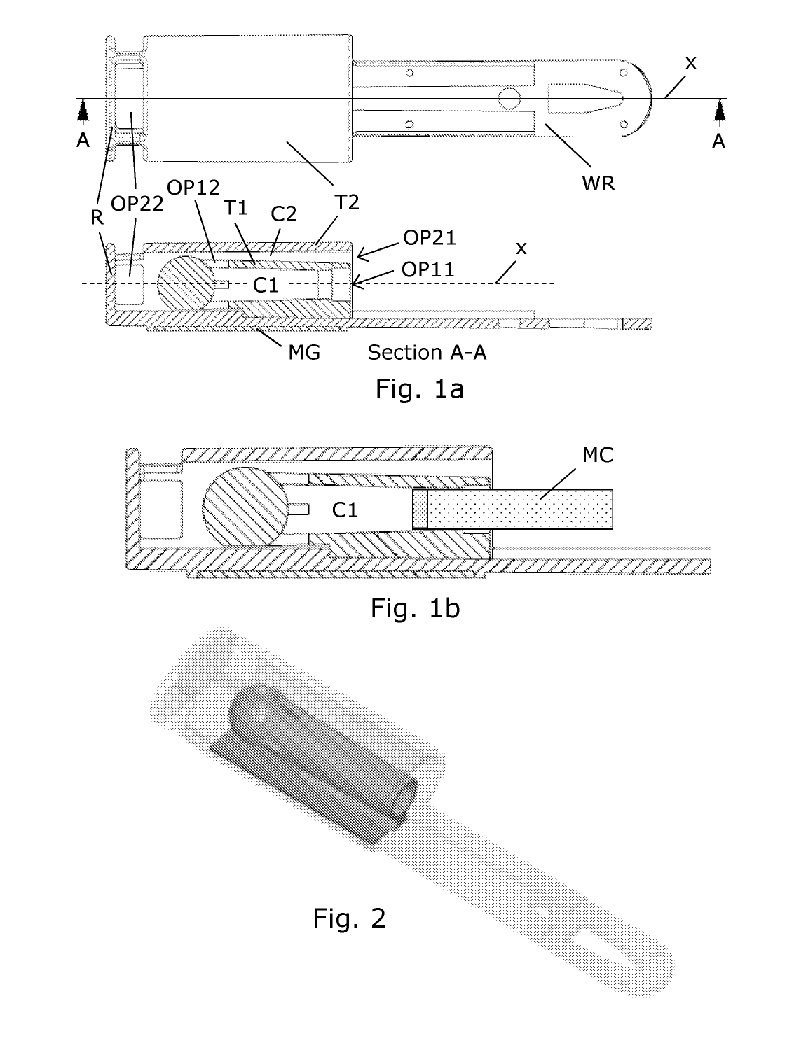

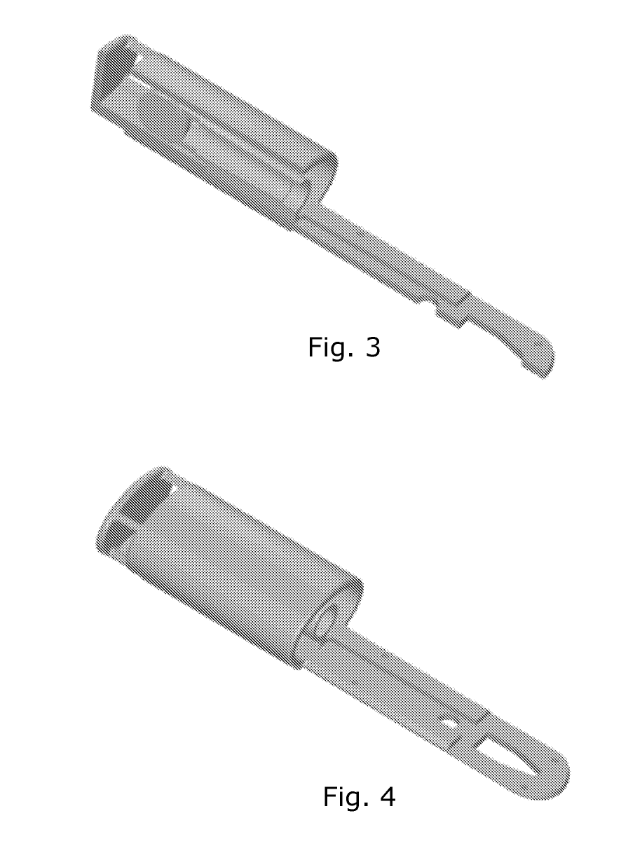

FIG. 1 shows a microphone mount embodiment suited for a miniature microphone with a diameter of such as 3 mm. An inner tube T1 is arranged in a cavity C2 formed by an outer tube T2. A diameter of 3-6 mm may be preferred, e.g. 4 mm or 5.5 mm, to fit to known miniature microphones from established microphone manufactures.

The slightly conically shaped inner tube T1 forms an inner cavity C1, i.e. it has a slightly decreasing outer diameter towards its first end, where it has a circular opening OP11 arranged to receive a microphone for capturing sound in the inner cavity C1. The inner tube T1 further has four openings OP12 in the form of apertures which are arranged to allow acoustic waves to enter the inner cavity C1 from an outer surface of the inner tube T1. The four apertures OP12 are positioned near a second end opposite the first end of the inner tube T1. Each of the four apertures OP12 extend parallel with a longitudinal axis x of the inner tube T1 at different angular positions around a circumference of the inner tube T1. Such as each of the four apertures having a length of 2-4 mm and a width of 0.5 mm to 2 mm, preferably a length of 3 mm and a width of 1 mm. A second end of the inner tube T1 is preferably acoustically closed, and it is seen to have a spherical shape. However, it is to be understood that the second end of the inner tube T1 may be flat or have an other shape.

The elliptically shaped outer tube T2 forms an inner cavity C2 between first and second ends. The first end forms an opening OP21 dimensioned to receive the inner tube T1. There is also a second opening OP22 at the second end opposite the first end of the outer tube T2. The inner cavity C2 is also elliptically shaped, and it is shaped to accommodate the inner tube T1, and as seen the full length of the inner tube T1 is arranged inside the cavity C2 formed by the outer tube T2. This means that all of the apertures OP12 of the inner tube T1 are arranged inside the inner cavity C2 of the outer tube T2, so as to receive sound waves which have been reflected on the inner wall of the inner cavity C2 of the outer tube T2. The outer tube has a length of 2-3 cm from the first to the second end.

The outer tube T2 is monolithically formed with a plane sound reflecting surface R arranged at a distance from the second end of the outer tube T2 so as to reflect sound waves into the inner cavity C2 of the outer tube T2. The sound reflecting surface R is perpendicular to or substantially perpendicular to a longitudinal axis x of the outer tube T2. As seen, the spherical shape end of the inner tube T1 faces towards the sound reflecting surface R outside the second opening OP22 of the outer tube T2. This spherical shape serves to diffract or disperse sound waves reflected by the sound reflecting surface R into the inner cavity C2 of the outer tube T2, so as to provide a more random distribution of sound waves entering the inner cavity C2 of the outer tube T2. The sound reflecting surface R is positioned such as 3-10 mm, e.g. 3-6 mm, outside where the outer tube T2 ends, thus also meaning in the shown embodiment, that the second opening OP22 at the second end of the outer tube T2 has this length, since this opening OP22 is formed as a circumferential opening of the major part of the second end of the outer tube T2. In fact, the sound reflecting surface R in the shown embodiment can be seen as constituting the second end of the outer tube T2, and wherein the second opening OP22 is arranged at an outer wall of the outer tube T2, adjacent to the sound reflecting surface R.

The outer tube T2 is further made monolithically with a protruding part WR arranged for fixing the microphone mount to a person or a person's clothing by means of through-going holes for receiving a fixing string or wire, such as for sewing the microphone mount to a clothing part, and further holes for fixing the wire from the microphone, so as to provide a pull relief of a connecting wire to the microphone. E.g. the triangular shaped through-going hole can be used to fix the microphone mount to a button of a person's shirt. As seen, the protruding part WR is positioned at the first end of the outer tube T2 and parallel with the wall forming the outer tube T2. The microphone mount is arranged to be fixed e.g. behind a person's tie with the protruding part WR pointing upwards, meaning that the openings OP11, OP12 will face upwards towards the person's mouth. This also means that the sound reflecting surface R captures and reflects sound from the person's mouth.

The inner tube T1, the outer tube T2, and the sound reflecting surface R are dimensioned so as to provide an acoustic labyrinth effect between incoming acoustic waves and a position in the inner cavity C1 of the inner tube T1, where sound can be captured by a microphone, so that sound in the frequency range 3-10 kHz, is acoustically amplified, preferably by such as 6 dB or more.

The illustrated microphone mount embodiment has a measured amplification of around 12 dB in the frequency range 3-8 kHz. However, it is to be understood that the specific acoustic design with respect to frequency range and amplification may be changed according to the specific use of the microphone mount. E.g. the specific design can be based on the theory and formulas by Richard Bolt regarding acoustic resonance frequencies in a space. The illustrated embodiment is based on such calculations of resonance frequencies based on the following dimensions: a length of 38 mm, a height of 8 mm and a width of 15 mm for the outer tube T2.

The inner tube T1 and the outer tube T2 are formed as separate elements arranged to be assembled. The outer tube T2 has a trace along its inner wall serving to engage with an outer protruding part of the inner tube T1, so as to allow insertion of the inner tube T1 into the inner cavity C2 of the outer tube (T2) along the trace via the opening OP11 in the first end of the outer tube T2.

Both the outer tube T2 and the inner tube T1 can be formed as separate monolithic elements form in a rubber material. This will serve to prevent noise due to friction with the person's clothes in the hidden position behind the clothes, e.g. a tie. Further, this reduces unwanted vibrations to be transmitted into the inner cavity of the inner tube T1, where it can be picked up by the microphone.

On a back side of the outer tube T2 a flat magnet MG is fixed, and this magnet MG can be used for fixing the microphone mount via a corresponding metal element or magnet. As an alternative to the magnet MG, a steel plate can be fixed to the microphone mount, thus requiring a magnet for fixing to a clothing part, such as to a shirt or a back tape of a tie etc.

FIG. 1b shows a miniature microphone MC positioned to capture sound in the inner cavity C1 of the inner tube T1.

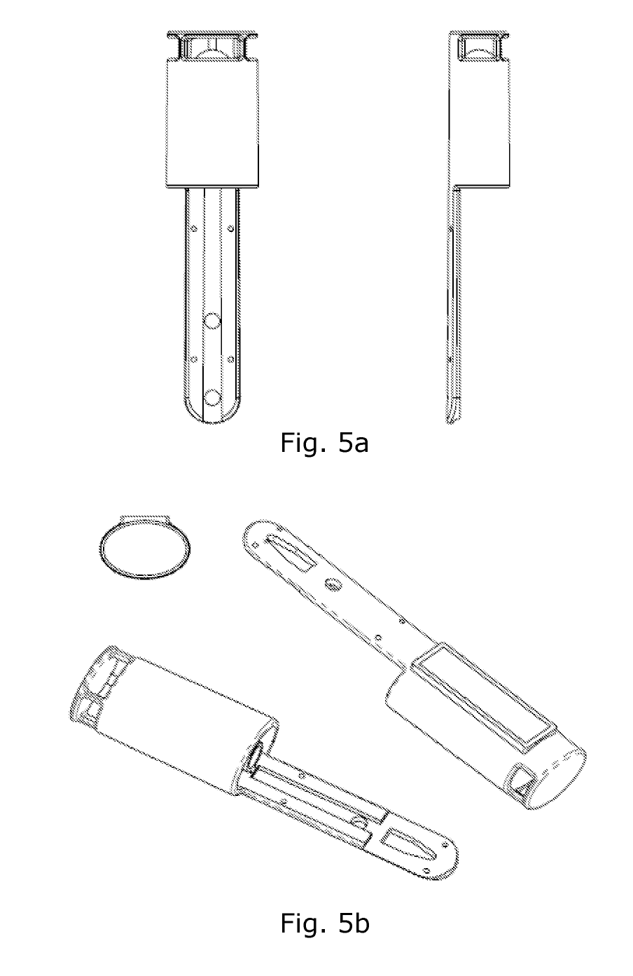

FIG. 2 shows a transparent 3D view of the microphone mount, where the position of the inner tube T1 inside the outer tube T2 is clearly seen.

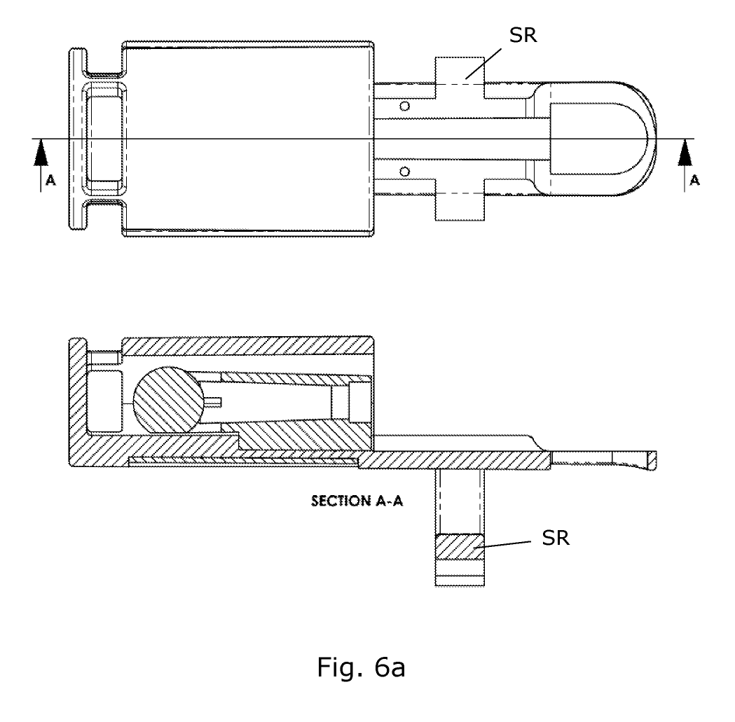

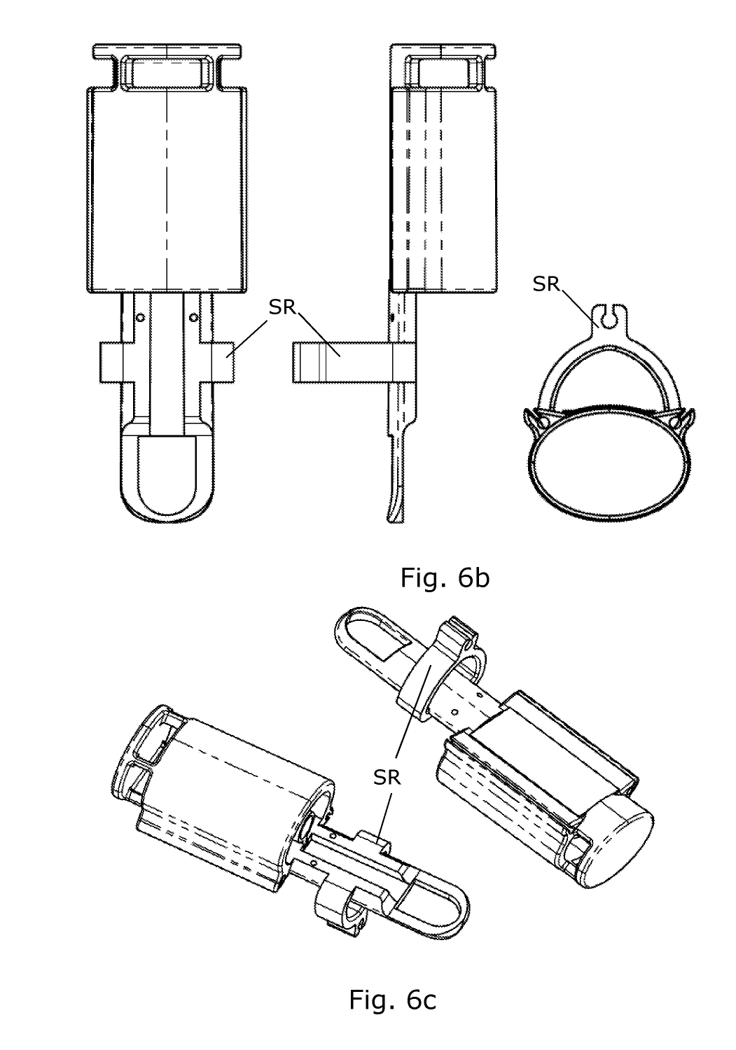

FIG. 3 shows a cut-away 3D view of the microphone mount, while FIG. 4 shows a 3D view of the microphone mount from outside.

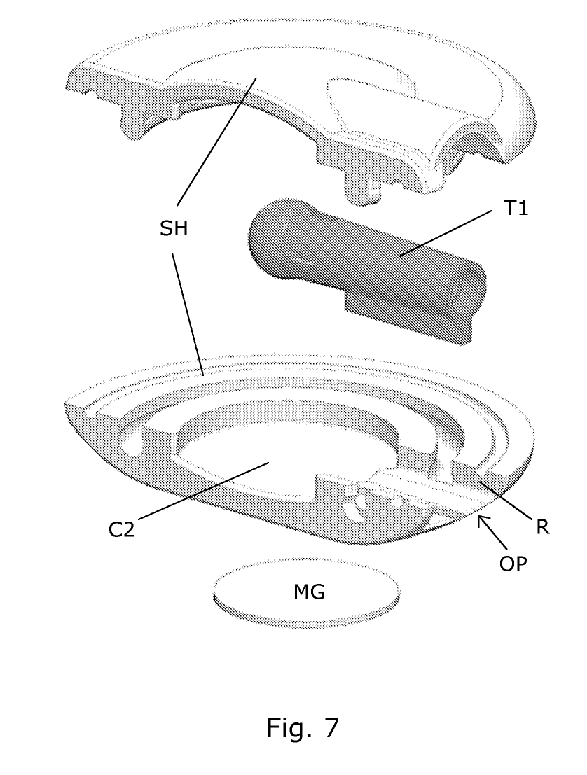

FIGS. 5a and 5b show line sketches with different views of the same microphone mount embodiment.

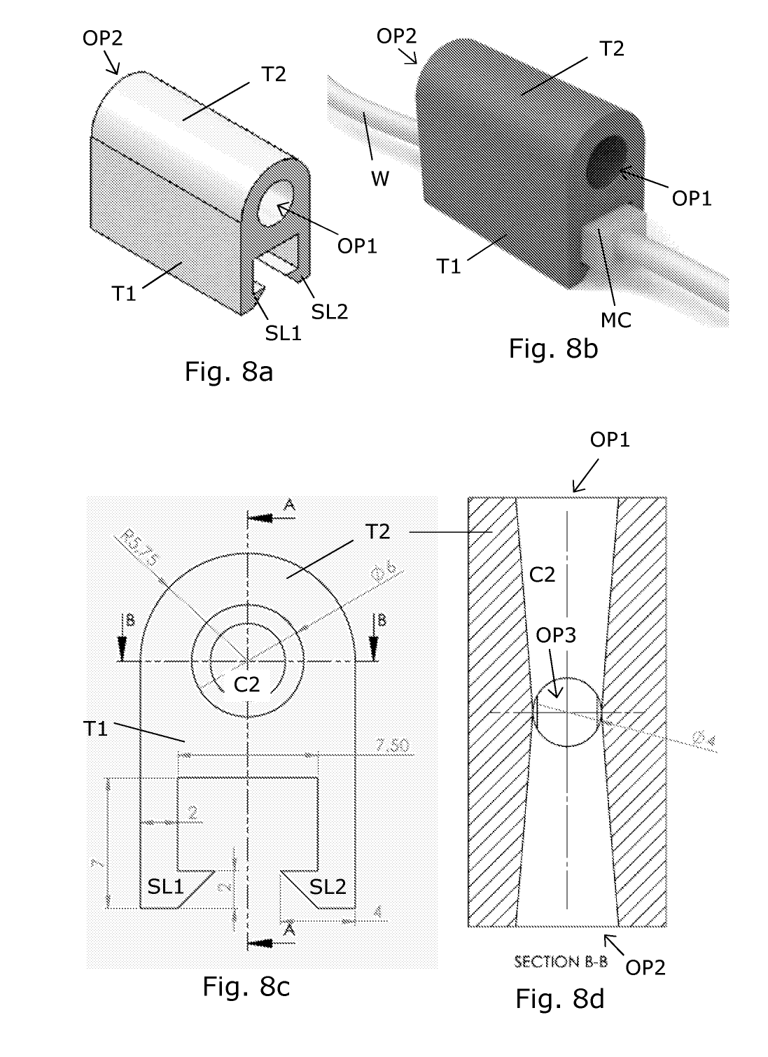

FIGS. 6a-6c show different views of an alternative version of the embodiment shown in the previous figures. This version has a microphone wire strain relief structure SR.

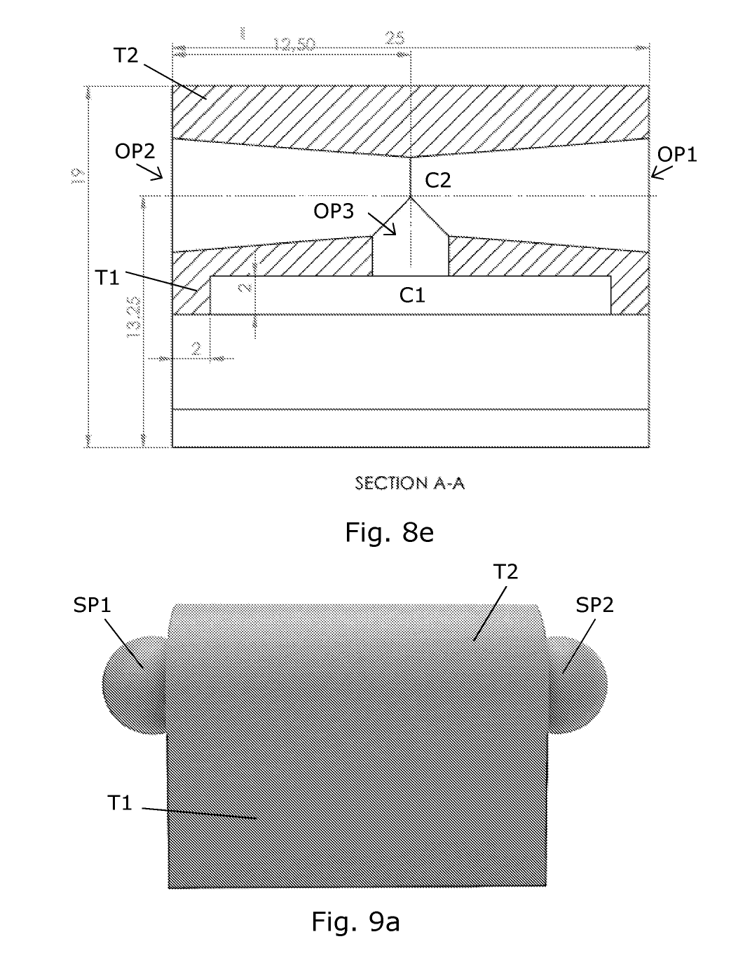

FIG. 7 shows a different embodiment having a flat structure, and thus being suited to be placed hidden behind the clothes of a person, e.g. positioned around the solar plexus region of a person. Preferably, the outer surface of this microphone mount embodiment has a smooth surface formed in a rubber material, so as to minimize acoustic noise from friction with the person's clothes.

In this embodiment, the outer chamber SH is flat and forms a flat inner cavity C2. Specifically, the structure forming the outer chamber SH has a general circular shape, thus forming a microphone mount with a general flat dome shaped or UFO disc shaped structure. The outer chamber SH has one opening OP arranged to receive incoming sound and a passage between the opening OP and the inner cavity C2 has a wall R serving to reflect sound into the inner cavity C2. The one opening OP serves in addition as opening for receiving a microphone to enter the inner tube T1. The inner tube T1 is shown in this embodiment to be similar to the one described in the foregoing. The opening OP is meant to turn upwards, i.e. towards the mouth of a person wearing the microphone mount.

As seen, the structure forming the outer chamber SH is split into a upper and a lower part which can be snap locked together.

A magnet MG is attached to an outer surface of the outer chamber SH so as to allow the magnet to fix the microphone mount onto a part of a person's clothes by means of a matching magnetic material.

The structure forming the outer chamber SH has one or more channels inside which can preferably serve as microphone wire strain relief.

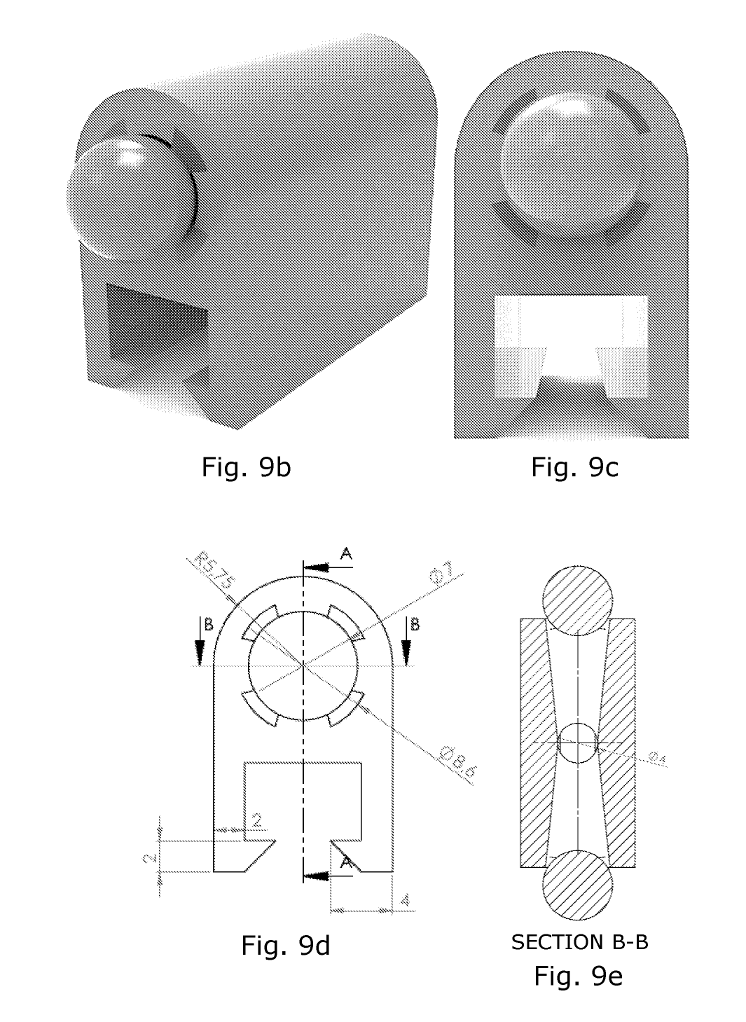

FIGS. 8a-8e show different views of a microphone mount embodiment formed by a rubber material and having a snap lock mechanism SL1, SL2 arranged to be snapped onto a microphone MC which is placed on a wire W, especially a wire W leading to an ear plug. Hereby, the microphone mount will improve sound captured by the microphone MC, e.g. to provide clear speech from a user for phone conversations etc. In this embodiment, the inner cavity C2 of the outer chamber T2 is tube shaped with first and second openings OP1, OP2 at respective ends of the tube shape, serving to reflect incoming sound to guide sound towards the inner cavity C1 of the inner chamber T1. An opening (OP3) inside the tube shaped inner cavity C2 of the outer chamber T2 serves to connect the outer cavity T2 with the inner cavity C1 of the inner chamber T1. Especially, it is seen that the cross sectional area of the tube shaped inner cavity C2 decreases from the first opening OP1 towards the opening OP3 connecting to the inner cavity (C1) of the inner chamber T1, namely forming a conical tube shaped inner cavity C2. Further, a cross sectional area of the tube shaped inner cavity C2 decreases from the second opening P2 towards the opening OP3 connecting to the inner cavity C1 of the inner chamber T1, also in a conical manner.

Preferably, the structure forming the outer chamber T2 and the inner chamber T1 is a monolithic structure, such as a monolithic structure formed by a rubber material.

Snap-lock mechanism SL1, SL2 being monolithically formed with the structure forming the inner and outer chambers T1, T2 is arranged to attach the microphone mount onto a microphone MC, and the specific embodiment is shaped to fit to a microphone MC with a box shaped outer structure with its acoustic opening facing perpendicular to a direction of the wire on which it is mounted.

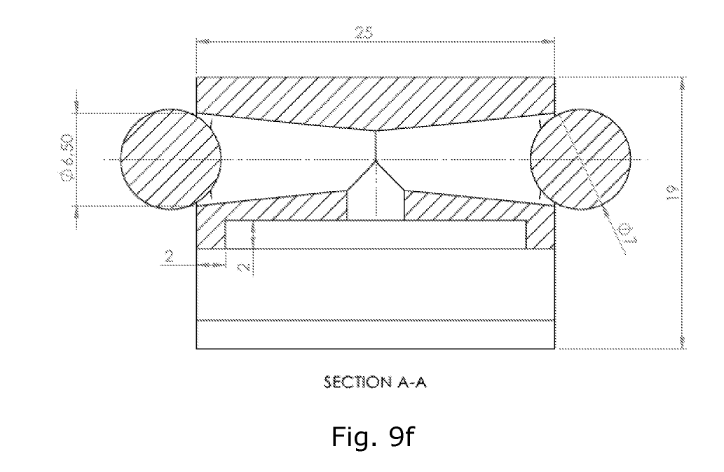

FIGS. 9a-9f show different views of an ear plug microphone mount embodiment similar to the one of FIGS. 8a-8e, however with reflecting elements SP1, SP2 in the form of spherical elements arranged at both of the openings OP1, OP2 to the outer chamber T2, so as to reflect sound into the inner cavity C2 of the outer chamber T2. This provides a boost at higher frequencies, and this may also be achieved by reflecting elements with other shapes than spherical.

The microphone mount according to the invention is applicable for capturing especially human voice, where it is preferred that the microphone is hidden on a person behind his/her clothes, and where it is desired to have a clear and distinct sound from the person's voice. Thus, it is especially applicable in all sorts of film and video production.

A set of embodiments E1-E26, to be define below, correspond to FIGS. 1-6, and these embodiments of the microphone mount can be used with existing high quality miniature microphone and result in a clear voice recording, when placed and hidden behind clothes, e.g. a tie, of a person, namely with the first ends of the tubes facing upwards towards the person's mouth. This is possible with the inner/outer tube and sound reflecting surface design which allows a microacoustic labyrinth effect for sound coming from the person's mouth, which enters the outer tube via its first end (facing toward the mouth of the person) and via its second end due to reflection from the sound reflecting surface.

With the inner tube positioned inside the outer tube, sound waves are reflecting at the inner surface of the outer tube and thus enters the inner cavity of the inner tube via the openings therein, and inside the inner cavity of the inner tube, sound is finally captured by a microphone, preferably a pressure gradient type of microphone. With this acoustic micro labyrinth effect, it is possible to acoustically amplify sound in the frequency range 3-10 kHz which serves to provide a more clear sound with enhanced speech intelligibility, thus compensating for the attenuation effect of the clothes, e.g. tie, and the position away from the person's mouth. Further, the microphone mount design introduces a number of short sound reflections, i.e. act like an acoustic delay-line, which introduces reflections within the first 10 ms of the direct sound arriving at the microphone, and this itself also introduces a positive “airy” effect on the perceived sound. It has further been found that the microphone mount is also advantageous for use in recording sound from a musical instrument, e.g. an acoustic guitar or a piano.

Further, the microphone mount design is suited for manufacturing in a soft or flexible material which can help to reduce pick-up of vibrations from the person's body, and helps to reduce noise (such as crackling noise) from friction with the clothes when the person moves.

E1. A microphone mount arranged to receive a microphone (MC), the microphone mount comprising

an inner tube (T1) forming an inner cavity (C1), wherein a first end of the inner tube (T1) has an opening (OP11) arranged to receive a microphone for capturing sound in the inner cavity (C1) of the inner tube (T1), and with one or more openings (OP12) arranged to allow acoustic waves to enter the inner cavity (C1) from an outer surface of the inner tube (T1),

an outer tube (T2), forming an inner cavity (C2) between a first end and a second end opposite the first end, wherein the first end has an opening (OP21), and wherein there is a second opening (OP22) at the second end of the outer tube (T2), and wherein the inner cavity (C2) of the outer tube (T2) is shaped to accommodate at least a part of the inner tube (T1), and

a sound reflecting surface (R) arranged at a distance from the second end of the outer tube (T2) so as to reflect sound waves into the inner cavity (C2) of the outer tube (T2).

E2. Microphone mount according to E1, wherein the inner tube (T1), the outer tube (T2), and the sound reflecting surface (R) are dimensioned so as to provide an acoustic labyrinth effect between incoming acoustic waves and a position in the inner cavity (C1) of the inner tube (T1), where sound can be captured by a microphone (MC), so that sound in the frequency range 3-6 kHz, preferably 3-10 kHz, is amplified, preferably by at least 3 dB, more preferably by at least 6 dB.

E3. Microphone mount according to E1 or E2, wherein said one or more openings (OP12) of the inner tube (T1) comprises one or more apertures or slids (OP12) arranged to allow acoustic waves reflected from a wall of the inner cavity (C2) of the outer tube (T2) to enter the inner cavity (C1) of the inner tube (T1).

E4. Microphone mount according to E3, wherein said one or more apertures or slids (OP12) are positioned between the first end of the inner tube (T1) and a second end of the inner tube (T1) opposite the first end, such as the second end of the inner tube (T1) being closed.

E5. Microphone mount according to E3 or E4, wherein said one or more openings (OP12) of the inner tube (T1) are constituted by at least two apertures or slids, such as at least two apertures extending parallel with a longitudinal axis of the inner tube (T1) at different angular positions around a circumference of the inner tube (T1).

E6. Microphone mount according to any of E1-E5, wherein a second end of the inner tube (T1) opposite the first end of the inner tube (T1) is closed, such as the second end of the inner tube (T1) and has a spherical shape.

E7. Microphone mount according to any of E1-E6, wherein at least a part of, preferably all of, said one or more limited openings of the inner tube (T1) are positioned in the inner cavity of the outer tube (T2).

E8. Microphone mount according to any of E1-E7, wherein the inner tube (T1) has a circular or substantially circular cross section, such as the inner tube (T1) having a slightly decreasing outer diameter towards the first end.

E9. Microphone mount according to any of E1-E8, wherein the outer tube (T2) has an elliptical or substantially elliptical cross section, such as the outer tube (T2) forming an inner cavity (C2) with an elliptical or substantially elliptical cross section, such as the outer tube (T2) forming an inner cavity with as a constant or substantially elliptical or substantially elliptical cross section from the first end to the second end.

E10. Microphone mount according to any of E1-E9, wherein the inner tube (T1) and the outer tube (T2) are formed as separate elements arranged to be assembled.

E11. Microphone mount according to any of E1-E10, wherein the outer tube (T2) has a trace along its inner wall serving to engage with an outer part of the inner tube (T1), so as to allow insertion of the inner tube (T1) into the inner cavity (C2) of the outer tube (T2) along the trace.

E12. Microphone mount according to any of E1-E11, wherein the sound reflecting surface (R) is perpendicular to or substantially perpendicular to a longitudinal axis (x) of the outer tube (T2).

E13. Microphone mount according to any of E1-E12, wherein the sound reflecting surface (R) and the outer tube (T2) are constituted by one single monolithic element, such as one single monolithic element formed by a silicone or rubber based material.

E14. Microphone mount according to E13, wherein said one single monolithic element comprising a protruding part (WR) arranged for fixing the microphone mount to a person or a person's clothing, such as the protruding part (WR) having one or more through-going holes for receiving a fixing string or wire, such as the protruding part (WR) being arranged at the first end of the outer tube (T2).

E15. Microphone mount according to any of E1-E14, wherein the outer tube (T2) has a length of 1-4 cm, preferably 2-3 cm, measured from the first end to the second end.

E16. Microphone mount according to any of E1-E15, wherein the inner tube (T1) has a length of 1-4 cm, preferably 2-3 cm, measured from the first end to the second end.

E17. Microphone mount according to any of the preceding claims, wherein the inner tube (T1) has a length equal to or substantially equal to a length of the outer tube (T2), and wherein the first end of the inner tube (T1) and the first end of the outer tube (T2) are longitudinally aligned.

E18. Microphone mount according to any of E1-E17, wherein a cross sectional area of the inner cavity (C2) of the outer tube (T2) is a factor of 2-4 times an outer cross sectional area of the inner tube (T1).

E19. Microphone mount according to any of E1-E18, wherein the sound reflecting surface (R) is arranged at a distance of 2-15 mm, such as 3-10 mm, outside the second end of the outer tube (T2).

E20. Microphone mount according to any of E1-E18, wherein the sound reflecting surface (R) constitutes the second end of the outer tube (T2), and wherein said second opening (OP22) is arranged at an outer wall of the outer tube (T2), adjacent to the sound reflecting surface (R).

E21. Microphone mount according to any of E1-E20, wherein the opening (OP11) in the first end of the inner tube (T1) is preferably shaped to provide an acoustically tight fit around a specific microphone (MC).

E22. Microphone mount according to any of E1-E21, wherein the opening (OP11) in the first end of the inner tube (T1) has a diameter of 2-4 mm.

E23. Microphone mount according to any of E1-E22, wherein the inner tube (T1) is designed so that sound waves will primarily enter the inner cavity (C2) of the inner tube (T1) via said one or more openings (OP12).

E24. Microphone mount according to any of E1-E23, wherein the inner tube (T1), the outer tube (T2), and the sound reflecting surface R, are designed so as to act as an acoustic delay line.

E25. Microphone mount according to any of E1-E24, wherein at least an outer surface of the outer tube (T2) is formed by a material serving to reduce or eliminate acoustic noise caused by friction between clothing and the outer surface of the outer tube (T2), preferably a soft or flexible material.

E26. Microphone mount according to E25, wherein at least the outer surface of the outer tube (T2) is formed by a material comprising a substantial amount of: silicone and/or rubber.

To sum up: the invention provides a microphone mount arranged to receive a microphone (MC), the microphone mount comprising an inner tube (T1) forming an inner cavity (C1) with an opening (OP11) arranged to receive a microphone for capturing sound in the inner cavity (C1) of the inner tube (T1), and with one or more openings (OP12) arranged to allow acoustic waves to enter the inner cavity (C1). An outer tube (T2) forming an inner cavity (C2) with first and second ends having an openings (OP21, OP22). The inner tube (T1) is arranged in the inner cavity (C2) of the outer tube (T2). A sound reflecting surface (R) is arranged at a distance from the second end of the outer tube (T2) so as to reflect incoming sound waves into the inner cavity (C2) of the outer tube (T2). Such microphone mount can provide a substantial acoustical amplification of sound in the frequency range 3-10 kHz, to allow clear voice recordings even if hidden behind a person's clothes, such as hidden behind a tie. This allows application for voice recordings during film recordings.

Although the present invention has been described in connection with the specified embodiments, it should not be construed as being in any way limited to the presented examples. The scope of the present invention is to be interpreted in the light of the accompanying claim set. In the context of the claims, the terms “including” or “includes” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

1-44. (canceled)

45. A microphone mount configured to receive a microphone, the microphone mount comprising
an inner chamber forming an inner cavity, wherein a first end of the inner chamber has an opening configured to receive the microphone, wherein the microphone is configured to capture sound in the inner cavity of the inner chamber, the inner chamber further comprising one or more openings configured to allow acoustic waves to enter the inner cavity from an outer surface of the inner chamber,
an outer chamber, forming an inner cavity having an opening, and wherein the inner cavity of the outer chamber is shaped to accommodate at least a part of the inner chamber, and
a sound reflecting surface configured to reflect sound waves into the inner cavity of the outer chamber.

46. The microphone mount according to claim 45, wherein the inner chamber, the outer chamber, and the sound reflecting surface are dimensioned so as to provide an acoustic labyrinth effect between incoming acoustic waves and a position in the inner cavity of the inner chamber where sound is captured by the microphone, such that sound in a frequency range of 3-10 kHz is amplified.

47. The microphone mount according to claim 45, wherein said one or more openings of the inner chamber comprise one or more apertures or slits configured to allow acoustic waves reflected from a wall of the inner cavity of the outer chamber to enter the inner cavity of the inner chamber.

48. The microphone mount according to claim 47, wherein said one or more apertures or slits are positioned between the first end of the inner chamber and a second end of the inner chamber opposite the first end.

49. The microphone mount according to claim 47, wherein said one or more openings of the inner chamber comprise at least two apertures extending parallel with a longitudinal axis of the inner chamber at different angular positions around a circumference of the inner chamber.

50. The microphone mount according to claim 45, wherein a second end of the inner chamber opposite the first end of the inner chamber is closed and has a spherical shape.

51. The microphone mount according to claim 45, wherein at least a part of said one or more openings of the inner chamber are positioned in the inner cavity of the outer chamber.

52. The microphone mount according to claim 45, wherein the inner chamber has a circular or substantially circular cross section.

53. The microphone mount according to claim 45, wherein the outer chamber has an elliptical or substantially elliptical cross section.

54. The microphone mount according to claim 45, wherein the inner chamber and the outer chamber are formed as separate elements configured to be assembled.

55. The microphone mount according to claim 45, wherein the outer chamber has a trace along an inner wall, wherein the trace is configured to engage with an outer part of the inner chamber to allow insertion of the inner chamber into the inner cavity of the outer chamber along the trace.

56. The microphone mount according to claim 45, wherein the sound reflecting surface is perpendicular to or substantially perpendicular to a longitudinal axis of the outer chamber.

57. The microphone mount according to claim 45, wherein the sound reflecting surface and the outer chamber comprise a single monolithic element.

58. The microphone mount according to claim 57, wherein said single monolithic element comprises a protruding part configured to fix the microphone mount to a person or a person's clothing.

59. The microphone mount according to claim 45, wherein the outer chamber is shaped as a tube having a length of 1-4 cm measured from a first end of the outer chamber to a second end of the outer chamber.

60. The microphone mount according to claim 45, wherein the inner chamber has a length of 1-4 cm measured from the first end of the inner chamber to a second end of the inner chamber.

61. The microphone mount according to claim 45, wherein the inner chamber has a length equal to or substantially equal to a length of the outer chamber, and wherein the first end of the inner chamber and the first end of the outer chamber are longitudinally aligned.

62. The microphone mount according to claim 45, wherein a cross sectional area of the inner cavity of the outer chamber is a factor of 2-4 times an outer cross sectional area of the inner chamber.

63. The microphone mount according to claim 45, wherein the sound reflecting surface is arranged at a distance of 2-15 mm outside the second end of the outer chamber.

64. The microphone mount according to claim 45, wherein the sound reflecting surface comprises the second end of the outer chamber, and wherein a second opening is arranged at an outer wall of the outer chamber and adjacent to the sound reflecting surface.

65. The microphone mount according to claim 45, wherein the opening in the first end of the inner chamber is shaped to provide an acoustically tight fit around the microphone.

66. The microphone mount according to claim 45, wherein the opening in the first end of the inner chamber has a diameter of 2-4 mm.

67. The microphone mount according to claim 45, wherein the inner chamber is configured such that sound waves primarily enter the inner cavity of the inner chamber via said one or more openings.

68. The microphone mount according to claim 45, wherein the inner chamber, the outer chamber, and the sound reflecting surface, are configured to act as an acoustic delay line.

69. The microphone mount according to claim 45, wherein at least an outer surface of the outer chamber is formed by a material configured to reduce or eliminate acoustic noise caused by friction between clothing and the outer surface of the outer chamber.

70. The microphone mount according to claim 69, wherein at least the outer surface of the outer chamber is formed by a material comprising a substantial amount of silicone or rubber.

71. The microphone mount according to claim 45, wherein the outer chamber is a flat structure forming a flat inner cavity arranged for position of at least an end of a tube shaped inner chamber.

72. The microphone mount according to claim 71, wherein the outer chamber has a generally circular or elliptical outer shape, such as having an outer shape as a flat dome.

73. The microphone mount according to claim 71, wherein the outer chamber has one opening arranged to receive incoming sound and having a reflecting surface arranged to reflect sound into the inner cavity.

74. The microphone mount according to claim 73, wherein said one opening is further configured to receive the microphone to enter the inner chamber.

75. The microphone mount according to claim 74, comprising a magnet attached to the outer chamber so as to allow the magnet to fix the microphone mount onto a part of a person's clothes by means of a matching magnetic material.

76. The microphone mount according to claim 45, wherein the inner cavity of the outer chamber is tube-shaped and comprises first and second openings at respective ends of the inner cavity, wherein the first and second openings of the inner cavity are configured to reflect incoming sound to guide the incoming sound towards the inner cavity of the inner chamber.

77. The microphone mount according to claim 76, wherein an opening inside the inner cavity of the outer chamber is configured to connect the inner cavity of the outer chamber with the inner cavity of the inner chamber.

78. The microphone mount according to claim 77, wherein a cross sectional area of the inner cavity decreases from the first opening towards the opening connecting to the inner cavity of the inner chamber.

79. The microphone mount according to claim 78, wherein a cross sectional area of the inner cavity decreases from the second opening towards the opening connecting to the inner cavity of the inner chamber.

80. The microphone mount according to claim 76, wherein a structure forming the outer chamber and the inner chamber is a monolithic structure.

81. The microphone mount according to claim 76, further comprising a reflecting element arranged at or near one or both of the openings of the inner cavity of the outer chamber, wherein the reflecting element is configured to reflect sound into the inner cavity of the outer chamber.

82. The microphone mount according to claim 76, further comprising a snap-lock mechanism configured to attach the microphone mount onto a microphone.

83. An ear plug device comprising a microphone mount according to claim 1.

84. The ear plug device according to claim 83, wherein the microphone mount is configured to be attached to an electrical wire of the ear plug device or to he attached to the microphone with the microphone being arranged on an electrical wire of the ear plug device.

85. A microphone assembly comprising
a microphone; and
a microphone mount configured to receive the microphone, the microphone mount comprising:
an inner chamber forming an inner cavity, wherein a first end of the inner chamber has an opening configured to receive the microphone, wherein the microphone is configured to capture sound in the inner cavity of the inner chamber, the inner chamber further comprising one or more openings configured to allow acoustic waves to enter the inner cavity from an outer surface of the inner chamber,
an outer chamber, forming an inner cavity having an opening, and wherein the inner cavity of the outer chamber is shaped to accommodate at least a part of the inner chamber, and
a sound reflecting surface configured to reflect sound waves into the inner cavity of the outer chamber.
